(19) United States
(12) Patent Application Publication
(10) Pub. No.: US 2007/0168427 A1
(43) Pub. Date: Jul. 19, 2007

(54) Messaging system and method

(76) Inventors: Eric Thelen, Aachen (DE); Matthew David Harris, Aachen (DE); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/577,199

(22) PCT Filed: Oct. 25, 2004
(86) PCT No.: PCT/IB04/52187

§ 371 Date: Feb. 22, 2007

(30) Foreign Application Priority Data
Oct. 29, 2003 (EP) 031 04 008.2

(51) Int. Cl. G06F 15/16

(52) U.S. Cl. 709/206

(57) ABSTRACT

A messaging system and method are described. The system includes acquisition means for acquiring audio and/or video data, e.g. microphones and cameras. The system further comprises database means (16). In the database (16), sets (32, 34, 36) of situational information (32a, 34a, 36a) and associated messaging information (32b, 34b, 36b) are stored. Processing means try to match the audio/video data to the stored situational information (32a, 34a, 36a). In case a match is found, the associated messaging information (32b, 34b, 36b) is presented using presentation means (18, 75a, 75b). The device and method are thus able to recognize a predefined situation observed by the acquisition means and to present a predetermined message associated with the recognized situation. This can advantageously be employed to present advertising messages adapted to a presently occurring situation.

The invention relates to a system and a method for messaging.

In the present context, the term “messaging” is understood to mean directing a piece of information to a person. Messaging devices and systems are commonly known in applications for industrial, office, home and mobile devices. Examples include unicast communication where only one receiver is addressed (e. g. telephone, e-mail) and multicast communication where a number of receivers are reached with one message (e. g. TV transmission).

A specific type of messaging is advertising, where the message content contains information about a product or service. It is generally desirable to send an advertising message to a single person or to a selected group of people who are likely to be interested in the product. For example, for a TV program a specific distribution of advertising content may be achieved by selecting the appropriate content (e. g. during a car race, car specific advertising content can be distributed to reach an interested group of persons). Reaching a specific person (unicast) or a specific group of persons (multicast) is also a central topic in all other types of messaging systems.

An example of a messaging system for distributing advertising content is given in US 2003/0066073. Here, a message system is activated upon presence of a human. The system includes a display, speaker, sensor for sensing the presence of a human and a processing unit. When a person is sensed, instructions for illuminating the display and displaying an advertising message are executed. Optionally, an audio message is played. Also, an aromatic unit can be attached to the system to obtain a specific odor.

However, a messaging system of this type is not well suited to individually select a specific person or a group of persons to deliver a message to. Also, the prior art systems are not able to detect objects or a specific situation to present an individual message according to the detected object or situation.

Accordingly, the object of this invention is to provide a messaging system, which is better suited to selectively deliver messages, especially advertising messages.

This object is solved according to the invention by a messaging system according to claim 1 and messaging method according to claim 11. Dependent claims relate to preferred embodiments of the invention.

The system according to the invention comprises presentation means for presenting a message. Possible examples include audio or video presentation means, e. g. an optical display or a speaker. Further, the presentation means may include means enabling an interactive dialogue, for example a keyboard or a touch-screen display.

In order to detect and recognize a certain individual and/or specific situations, the system includes acquisition means for audio and/or video data, which may be for example a video camera or digital still camera for acquiring video data or pictures and a microphone to acquire audio data. Also, a system according to the invention may include multiple acquisition devices, such as multiple video cameras and microphones.

Further, the invention includes database means, which may be any type of storage where information can be stored and read from without loss of information. The database means can be, but are not limited to optical, electronical or magnetic storage means in a personal computer. The database means store situational information and messaging information. Each set of situational information correspond to a specific, predetermined situation. The situational information serves to identify this situation.

The identified situational information is used to determine appropriate messaging information to present. In a simple case, there would be exactly one predetermined messaging information to present if a specific situation is recognized. It is, however, also possible that the recognized situation is only one out of a plurality of factors which serve to determine the messaging information to present. Another factor could be the presentation history (i.e. which messages have already been presented, to avoid repetitions). Still other factors could be the present time of day, the sequence of recognized situations (e.g. two specific situations recognized one after the other), or user profiles (explained below).

It is especially preferred that the messaging information is advertising content, and that the situational information is chosen such that it is likely that in the corresponding situation recipients are likely to show interest in the advertising message. The situational information is intended to allow the system to recognize if a certain, predetermined situation is present or not. An example of a corresponding set stored could be situational information corresponding to a person drinking a glass of wine, and associated herewith a messaging information an advertisement for a special wine.

In a preferred embodiment, the database means store situational information and associated messaging information in sets. If a situation corresponding to the situational information is detected, the associated messaging information is presented. In this way it is possible to present a predetermined message adapted to the situation. For example a set of situational information may describe the presence of a specific person in a room, and the corresponding message information would be a new e-mail for that person.

A central part of the system are processing means, which may be for example a microprocessor unit executing a corresponding program. The processing means are connected to the acquisition means to obtain said audio and/or video data. The processing means are also able to access the database means to obtain situational information and are configured to match said data to one or more of the sets of situational information obtained from the database.

The processing means further serve to select or configure messaging information. The database may contain a plurality of fixed sets of messaging information for the presently recognized situation, from which one is selected for display. It is, however, also possible that the finally presented message is dynamically configured. A template, i.e. a message structure may be associated with a recognized situation. Information to fill in the template may then be added from a plurality of sources, e.g. the names of recognized persons, or current information obtained from a special server.

The presentation means are configured to present the messaging information selected or configured by the processing means according to the matched set of situational information. Therefore, the presentation means obtain the matching messaging information from the processing means.

In a preferred embodiment, the processing means further include means for speech recognition. These means convert the acquired audio data to text data. In a preferred embodiment, matching of text data to situational information is accomplished by scanning of said text data for keywords stored as situational information in the database means.

In another preferred embodiment, the processing means include person identification means and the database means include sets of person identification. information. This person identification information may include for example picture information of that person and/or a voice pattern of that person. The processing means according to the preferred embodiment are able to identify a person from the acquired audio and/or video data using said person identification information. Further, the database means can include at least one profile of a person. The profile can be used to determine message information suitable for the identified person and could include information like interests, hobbies or any type of personal information.

Using a system according to the embodiment, it is possible, as mentioned before, to present personal information to a specific person, for example a newly arrived e-mail for that identified person. In a preferred application, the system is used to present advertising content specifically suited for a recognized situation and/or person.

According to a development of the invention, the processing means include means for object recognition to convert the video data to object data. The database includes object information stored with each set of situational information. The processing means is configured to match said object data to the object information obtained from the database. An example of a usage of the object information may be, as mentioned before, a person holding a glass of wine so that an advertising message for wine can be identified as messaging information.

In the following, examples of messaging systems according to the invention will be shown with regard to figures, where

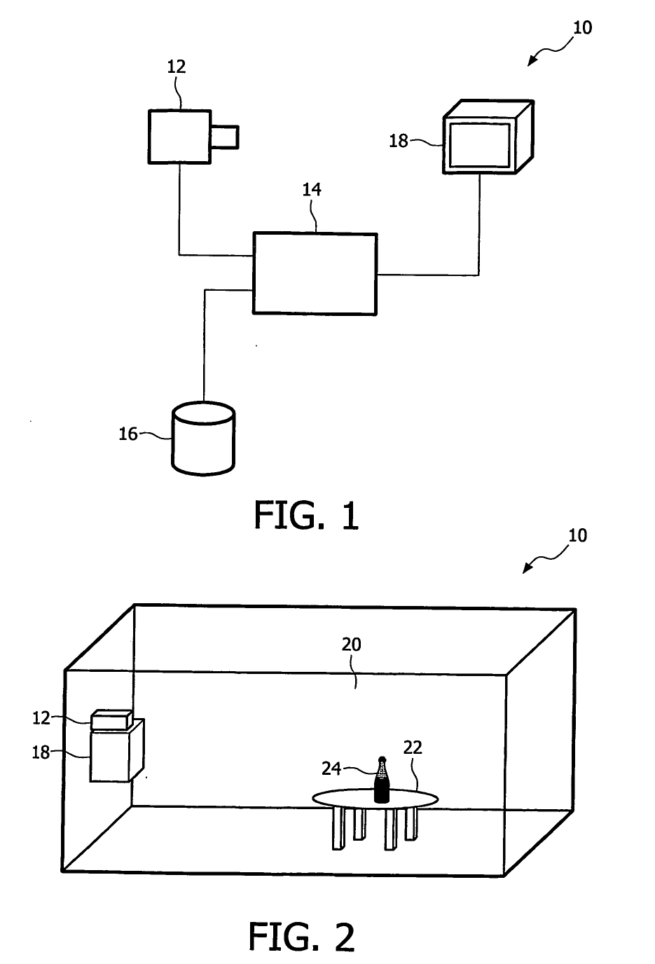

FIG. 1 shows a diagram of a messaging system according to a first embodiment of the invention;

FIG. 2 shows a symbolic representation of a device acquiring video data in a room;

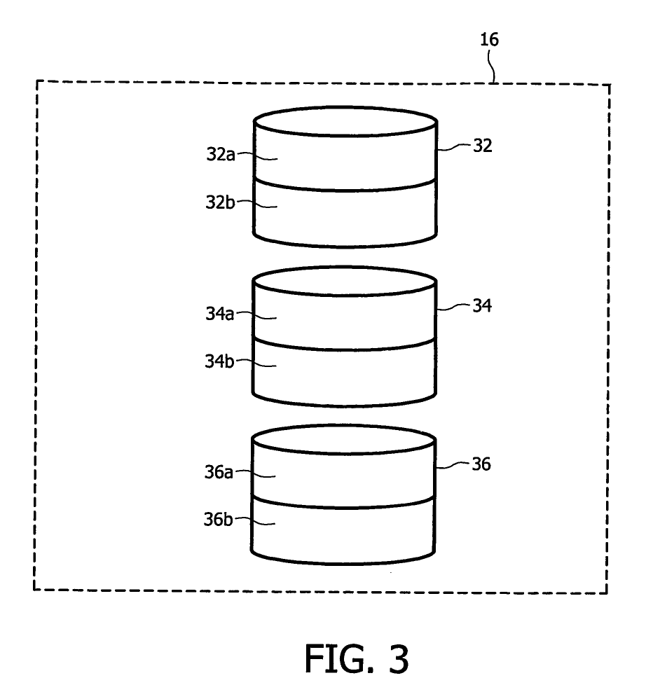

FIG. 3 shows a structural representation of a database;

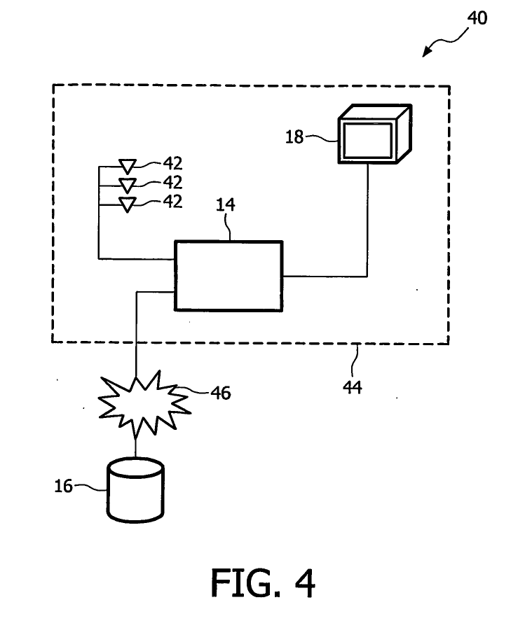

FIG. 4 shows a diagram of a messaging system according to a second embodiment of the invention;

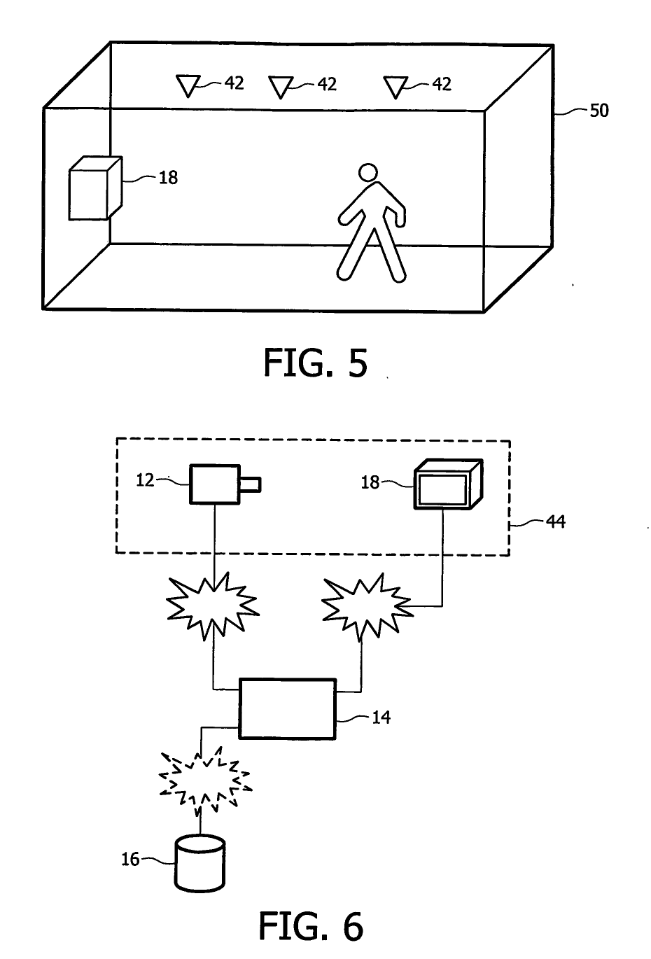

FIG. 5 shows a symbolic representation of a device acquiring audio data in a room;

FIG. 6 shows a diagram of a messaging system according to a third embodiment of the invention and

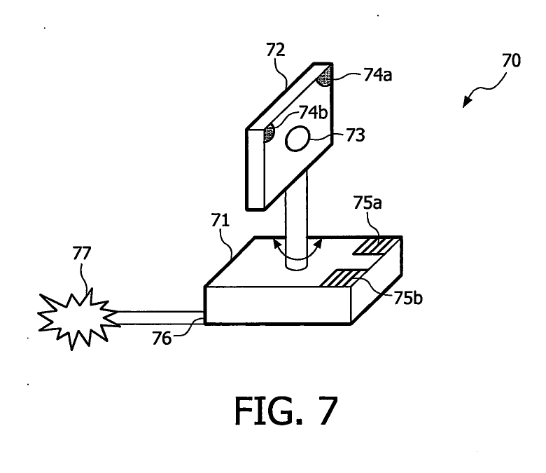

FIG. 7 shows a messaging device according to a fourth embodiment of the invention.

FIG. 1 shows the structure of a messaging system 10 according to a first embodiment of the invention. Here, a video camera 12 is connected to a central unit 14. The central unit obtains video data from the camera 12. The central unit 14 is further connected to a database 16, which it can access to retrieve stored information.

The system 10 uses the camera 12 to acquire current video data of a space to be observed. The central unit 14 includes a microprocessor, on which a program is executed to process the video data. The data is processed to recognize if one out of a number of situations stored in the database 16 is present. Data representing specific situations is stored in the database 16 as situational information.

The central unit 14 attempts to find a match between the video data and the stored situational information.

When a match is found, the central unit 14 obtains messaging information associated with the matched set of situational information from the database 16 and sends the messaging information to a connected display 18.

FIG. 2 shows the messaging system 10, which is installed in a room 20. The video camera 12 acquires video data of the room. Alternatively the system may include a multiplicity of cameras depending on room size and geometry (not shown). In FIG. 2, the room contains a table 22 with a bottle of wine 24. Additionally, but not shown here, some persons could be sitting around the table.

FIG. 3 shows a possible structure of the database 16 according to the invention. The database 16 stores sets 32, 34, 36 of situational information 32a, 34a, 36a and associated messaging information 32b, 34b, 36b.

In the present embodiment, the situational information includes object data relating to objects present in a specific situation. The messaging information is an advertising message associated with the situation identified by the situational information.

For example, the first set 32 of data corresponds to a situation where people in room 20 are drinking a bottle of wine 24. The situational data 32a includes object identification information on a wine bottle (e. g. possible shapes of wine bottles, size). The data 32a further includes graphic information about a table 22 and persons sitting at the table 22. Further, the data 32a includes object orientation and movement information defining possible, characteristic orientation and movement of the objects of the represented situation (e. g. the characteristic orientation of an open wine bottle, which will be generally standing vertically). This data allows to decide if a current situation in the room 20 observed by the camera 12 corresponds to the represented information (people are drinking wine) or not.

The first set 32 of data further comprises message data 32b, which is an advertising message announcing a special wine.

The further sets 34, 36 comprise situational information 34a, 36a for different, predefined situations, and associated advertising messages 34b, 36b.

The video camera 12 sends the acquired video data to the central unit 14 (not shown in FIG. 2), which may be installed in a nearby room. The central unit 14 compares the acquired video data to the sets of situational information obtained from the database.

The central unit 14 processes the video data to extract object information. Corresponding techniques for image and video processing are well known in the art. In the example of FIG. 2, the objects present in room 20 will be identified: table 22, with wine bottle 24, and persons sitting at table 22. This object identification and object movement data is then matched to the situational data 32a, 34a, 36a from data sets 32, 34,36.

This matching is a classification problem, where it is decided if the object data (identification and orientation/movement) corresponds to one of the sets 32, 34, 36, or if none of the stored situations match. There are well known classification methods available which allow fault tolerant matching.

In the example of FIG. 2, a match of the current situation in room 20 with data set 32 will be found. The system thus recognizes that in room 20 persons are sitting at a table and are drinking wine.

The central unit 14 retrieves the corresponding advertising message 32b from the database 16 and sends it to display 18. Display 18 displays the message. In this way, the people in room 20 are presented with an advertising message specifically adapted to this current situation (e. g. a special offer for wine), so that they are likely to be interested in this message.

Optionally, the system may include means for person identification and profiles of persons in the database. This may be advantageous to present more specific messages. For example, the group of persons in the room 20 could be successfully identified. The central unit 14 could access the database 16 to obtain individual profiles of the identified persons. Matching could be accomplished by finding interests in the profile which these persons share. This matched information may be combined with the object information acquired before, to obtain a more specific message. For example, the situation could be determined as “persons drinking wine”. Additionally, it is determined that the available interest profiles of the persons present show a common interest in France. These pieces of information could be combined and an advertising message for French wine could be presented. Naturally, it is not necessary to obtain situational information before the person identification, a system using only a person identification would also be imaginable.

FIG. 4 shows a second embodiment of a messaging system 40. In this embodiment, a number of microphones 42 serve as acquisition means. The central unit 14 and the display 18 are located on local premises 44, e. g. inside a house or a room. The database 16 is located in a remote location. This may be for example a content provider, or an advertising company. The database 16 is connected to the central unit 14 via a network connection 46.

As shown in FIG. 5, in a room 50, microphones 42 and a display 18 of the messaging system 40 of FIG. 4 are located. The central unit 14 and the data base 16 are not shown. The microphones 42 pick up the sounds in the room 44 and send the corresponding signals to the central unit 14. The central unit 14 performs voice recognition to convert the audio data to text data. The unit 14 then accesses the remote data base 16 over network 46 to obtain sets of situational information and matches the text data thereto.

In the second embodiment, the situational information is given as keywords. One data set in database 16 could include keywords related to vacations and travelling: “vacation”, “trip”, “hotel”, “flight” etc. The associated message could be an advertisement for a hotel or a holiday trip. If in a discussion in room 50 the stored keywords are used frequently, unit 14 will find a match and display the advertisement message retrieved from database 16 on display 18.

Matching could be accomplished by counting how often a specific keyword is used in comparison to other keywords. Also, semantic analyzing of the spoken phrases could be implemented.

The advertisement message presented can be fixed and predetermined for the recognized situation “people are discussing vacations”. Alternatively, it is also possible that the message is dynamically configured or selected from a plurality of messages. In an alternative embodiment, the database 16 contains a pointer to another remote server (not shown) where different offers for vacation trips are available. The messaging system 40 chooses one of these offers which is likely to be interested for the persons present, i.e. an offer which corresponds to the number of persons present.

In a further embodiment, the system uses audio person identification. Based on a profile of the successfully identified person stored in the database, specific messaging is possible, for example newly arrived e-mails for that person can be presented, but also messages relating to special interests of that person.

The use of one or more microphones 42 is depending on the room size and geometry. Also, the use of microphones 42 combined with one or more video camera 12 is possible. Using such a system could be advantageous for even close matching of messaging information to specific situations. For example, combining object recognition using video data with keyword identification using speech recognition audio could be useful. For example, in the situation of a group of persons looking at photos and talking about a foreign destination, the information that they may be interested in vacation adds up to the objects information obtained from video data and the keyword obtained from audio data.

FIG. 6 shows a system 30 according to a third embodiment of the invention, in which only a video camera 12 and a display 18 are located on local premises 44. In this embodiment, the central unit 14 and the database 16 are located at remote locations. The processor means could be located at an application provider's site, and the database 16 could be located for example at a content provider, distant from the application provider. Naturally, the processor unit 14 and the database 16 could also be located in a single remote location. This embodiment could be advantageous, because the central unit 14 and the database unit 16 can be easily accessed for service by a content provider. Also, the system could be expanded to access a plurality of databases. For example, this could be useful in the case that a plurality of content providers participate in the messaging system or a new content provider wants to join the system. Also, a system where one central unit 14 serves a plurality of local systems would be imaginable.

FIG. 7 shows a fourth embodiment of the invention. A messaging device 70 comprises a base 71 and a head unit 72 mounted rotatably on the base 71. The head unit 72 includes a camera 73 and two microphones 74a, 74b. The base unit 71 includes a motor (not shown) to rotate head unit 72 so that it faces in a desired direction.

The device 70 works as a messaging device. The microphones 74a, 74b and the camera 73 act as acquisition means to acquire audio and video data of the surroundings. A central unit as explained above is included in base 71 (not shown). The device 70 includes a network interface 76, connecting the device 70 to a data network 77. A database (not shown) as explained above is accessible over network 77. The base unit 71 of the device 70 further includes loudspeakers 75a, 75b which serve as presentation means.

The device 70 may be positioned in a room, where it observes the situation around it. The central unit will rotate the head unit 72 to acquire the objects present in the room with camera 73 and record sounds with microphones 74a, 74b. The audio and video data will then be matched to situational data retrieved from the external database, and corresponding stored audio advertising messages will be played over loudspeakers 75a, 75b.

It should be clear that the embodiments described above only give examples of possible implementations of a system and method according to the invention. The given combinations of local and remote placement of components (FIG. 1, 4 and 6) with audio and video acquisition (FIG. 2, 5) are by way of example only. In alternative embodiments, these aspects could be differently combined.

1. Messaging system, comprising
acquisition means (12, 42, 73, 74a, 74b) for acquiring audio and/or video data,
database means (16) for storing situational information (32a, 34a, 36a) and messaging information (32b, 34b, 36b),
processing means (14) for processing said data, said processing means (14) being configured to match said data to one of said sets of situational information (32a, 34a, 36a) and for selecting and/or configuring messaging information (32b, 34b, 36b) according to said matched situational information (32a, 34a, 36a),
presentation means (18, 75a, 75b) for presenting the selected or configured messaging information (32b, 34b, 36b).

2. A system according to claim 1, where
said database means are configured to store sets (32, 34, 36) of situational information (32a, 34a, 36a) and associated messaging information (32b, 34b, 36b),
and where said presentation means (18, 75a, 75b) present the messaging information (32b, 34b, 36b) associated with the matched set of situational information (32a, 34a, 36a).

3. A system according to claim 1, comprising
a device (70) including said acquisition means (73, 74a, 74b), said processing means and said presentation means (75a, 75b), said device (70) further including interface means (76) for connecting to a remote server, where said server includes said database means.

4. A system according to claim 1, comprising
a device including said acquisition means and said presentation means, said device further including interface means for connecting to a remote server, where said server includes said database means and said processing means.

5. A system according to claim 1, wherein said processing means (14) include means for speech recognition to convert said audio data to text data.

6. A system according to claim 4, wherein said situational information (32a, 34a, 36a) database means (16) includes keywords and said processing means (14) are configured to scan said text data for said keywords.

7. A system according to claim 1, wherein said database means (16) include sets of person identification information of at least one person and said processing means (14) include person identification means to identify a person using said data and said person identification information.

8. A system according to claim 7, wherein said database means (16) includes at least one profile of a person and said processing means (14) uses said profile to determine messaging information associated with said identified person.

9. A system according to claim 1, wherein said processing means (14) include means for object recognition to convert said video data to object data.

10. A system according to claim 9, wherein said situational information (32a, 34a, 36a) stored in said database means (16) includes object information and said processing means (14) are configured to compare said object data to said object information.

11. Messaging method, where
audio and/or video data are acquired;
a database (16) is accessed which stores sets (32, 34, 36) of situational information (32a, 34a, 36a) and associated messaging information (32b, 34b, 36b);
where said data is processed to match said data to one of said sets of situational information (32a, 34a, 36a) and
the messaging information (32b, 34b, 36b) associated with the matched situation information is presented.
